(19) United States
(12) Patent Application Publication
(10) Pub. No.: US 2004/0236657 A1
(43) Pub. Date: Nov. 25, 2004

(54) Method and system for estimating a bucket transition distribution of one or more bonds and for evaluating credit risk of collaterized debt obligations

(76) Inventors: Gyan P. Sinha, Englewood Cliffs, NJ (US); Andrew Bierbryer, New York, NY (US)

Correspondence Address: Steven B. Pokotilow, Stroock & Stroock & Lavan LLP, 180 Maiden Lane, New York, NY, 10038, US

(21) Appl. No.: 10/661,211

(22) Filed: Sep. 12, 2003

Related U.S. Application Data
(60) Provisional application No. 60/473,178, filed on May 23, 2003.

(51) Int. Cl. G06F 17/60

(52) U.S. Cl. 705/36

(57) ABSTRACT

Methods and systems for estimating a bucket transition distribution are disclosed. In certain embodiments, a plurality of price buckets is identified, bucket transition probabilities are calculated for a first bond, and a bucket transition distribution is estimated for the first bond using the calculated bucket transition probabilities. The process is then repeated for a predetermined number of simulations. Bucket transition probabilities are also calculated for a second bond, a bucket transition distribution is estimated for the second bond using the calculated bucket transition probabilities, and the estimated bucket transition distributions for the bonds are grouped, thereby enabling an evaluation of the credit risk of the bonds.

### CROSS-REFERENCES TO RELATED APPLICATIONS

This application claims the benefit of U.S. Provisional Application No. 60/473,178, filed May 23, 2003, which is incorporated herein by reference for all purposes.

### BACKGROUND OF THE INVENTION

1. Field of the Invention

Present invention relates generally to methods and systems for evaluating and pricing credit risk and, more particularly, to techniques for evaluating and pricing credit risk of collaterized debt obligations.

2. Description of Related Art

Collaterized Debt Obligations (CDO) are privately placed securitizations. Securitization is a process of converting assets into securities backed by those assets. A CDO structuring technique creates a special-purpose entity (SPE) to hold underlying collateral, which then issues securities backed by the underlying collateral pool. The underlying collateral's cash flows are then used to pay interest and principal on the issued securities. The CDO securities have higher credit quality than the underlying collateral profiles because of (a) diversification, and (b) tranching of the underlying collateral pool. Diversification redistributes risk by grouping or “pooling” numerous underlying collateral risk-return profiles, thereby creating a single risk-return profile on the underlying collateral pool. Tranching is used to create multiple risk-return profiles, namely, different classes of securities that carry different risk components defined by their payment priority and timing.

By allowing the risk in the underlying collateral to be segmented and re-prioritized into different, both lower and higher rated forms, the CDO structuring enabled new classes of investors to participate in the high-yield sector. In particular, the managed form allowed investors in the CDO market to gain exposure to a broadly diversified pool of credits where individual names within each sector were picked by a professional manager. For the equity investor in the CDO, the availability of long-term, non-recourse funding through the issuance of CDO liabilities created the potential for an attractive leveraged return profile, free from the fluctuations of short-term financing. Indeed, to the extent that the pricing on the underlying collateral reflects an illiquidity premium in markets dominated by rate-of-return, mark-to-market investors, a longer term funding vehicle has a natural advantage and can afford to evaluate the same cash flows at lower discount rates.

However, the volatility of the CDO market, and especially the high-yield market, introduces an uncertainty as to the collateral debt's propensity to default, recover, or be called. This has led to the market relying on subjective assumptions about default, recovery and call rates. For example, some of the market participants may choose to assume a default of all collateral pieces below a certain agency, such as triple-C collateral pieces, while others may choose to assume a default of all collateral pieces under a certain price, such as $50. Similarly, some market participants may use a previous three-month default rate in determining future CDO performance, while others may use a lifetime default rate. This variety of subjective assumptions results in too many permutations of spread and assumptions to allow for agreement to be reached between buyer and seller.

Even the historical data on defaults by ratings provided by agencies, such as Moody's, S&P, and Fitch IBCA, is less useful since they represent averages over a variety of past credit cycles, whereas market valuations naturally tend to weight the most recent credit cycle more heavily than prior ones. The historical default rate data provided by the rating agencies provide investors little reliability in predicting near-term credit events.

Accordingly, a need exists for an improved method and system for analyzing and estimating future CDO performance in the context of a structured transaction that would improve the CDO trading environment.

### SUMMARY OF THE INVENTION

The foregoing, as well as other, needs are satisfied by the present invention. According to certain embodiments, methods and systems for estimating a bucket transition distribution for one or more bonds are disclosed. In one embodiment, the process for estimating a bucket transition distribution includes the steps of identifying a plurality of price buckets, calculating bucket transition probabilities for a first bond, and estimating a bucket transition distribution for the first bond using the calculated bucket transition probabilities. This process is then repeated for a predetermined number of simulations. The method also includes calculating bucket transition probabilities for a second bond, estimating a bucket transition distribution for the second bond using the calculated bucket transition probabilities, and grouping the estimated bucket transition distributions for the bonds, thereby enabling an evaluation of the credit risk of the bonds.

Furthermore, a computer readable medium for estimating a bucket transition distribution for one or more bonds includes a program that causes a processor to implement the above-listed steps.

Still further, a device for estimating a bucket transition distribution according to the present invention includes a processor configured to identify a plurality of price buckets, calculate bucket transition probabilities for a first bond; and estimate a bucket transition distribution for the first bond using the calculated bucket transition probabilities. The processor is also configured to estimate bucket transitions until an exit state or a maturity date of the first bond is reached, thereby completing the first simulation. The processor repeats this process for a predetermined number of simulations. In the preferred embodiment, the processor is also configured to calculate transition probabilities for a second bond, estimate a bucket transition distribution for the second bond using the calculated bucket transition probabilities, and group the estimated bucket transition distributions for the bonds, thereby enabling an evaluation of the credit risk of the bonds.

Additionally, the inventors have found that the divergence between market perceptions of credit risk, for example, as determined by the embodiments herein, and ratings-implied credit risk is large for most credits. Bond market prices tend to be better aggregators of information regarding credit risk than the credit-rating agencies. Thus, bond prices reflect valuable information regarding future default, recovery and call propensities of firms, and, when employed in the systems and methods described herein, are efficient proxies of such information.

### BRIEF DESCRIPTION OF THE DRAWINGS

The following figures, which are included herewith and form a part of this application, are intended to be illustrative examples and not limiting of the scope of the present invention.

FIG. 1 is a flow chart of the method according to one exemplary embodiment of the present invention.

FIG. 2 is a balance matrix of bond price transitions between buckets, according to an exemplary embodiment of the present invention.

FIG. 3 is a cumulative balance matrix of bond price transitions between buckets based on

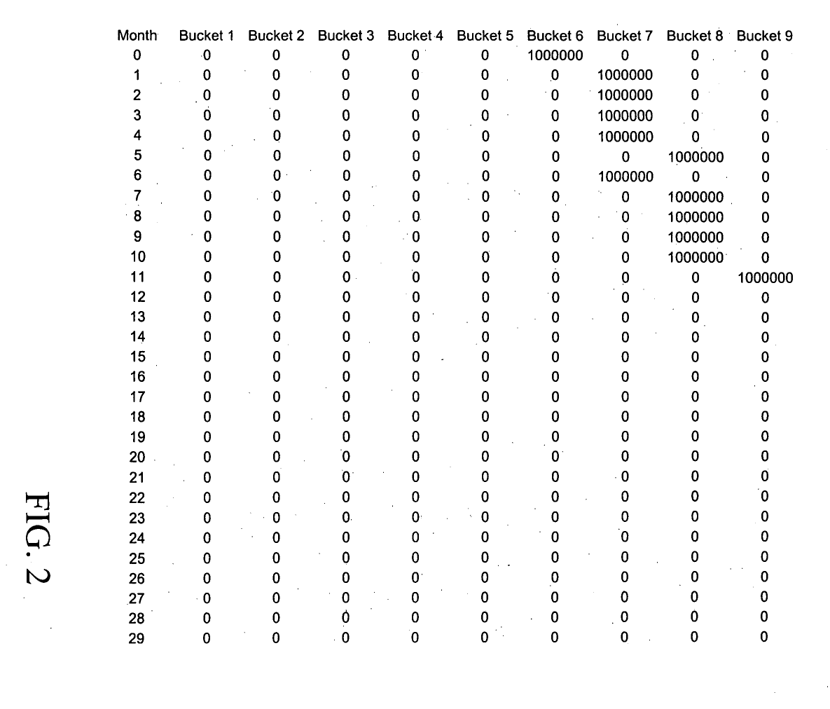

FIG. 2 according to an exemplary embodiment of the present invention.

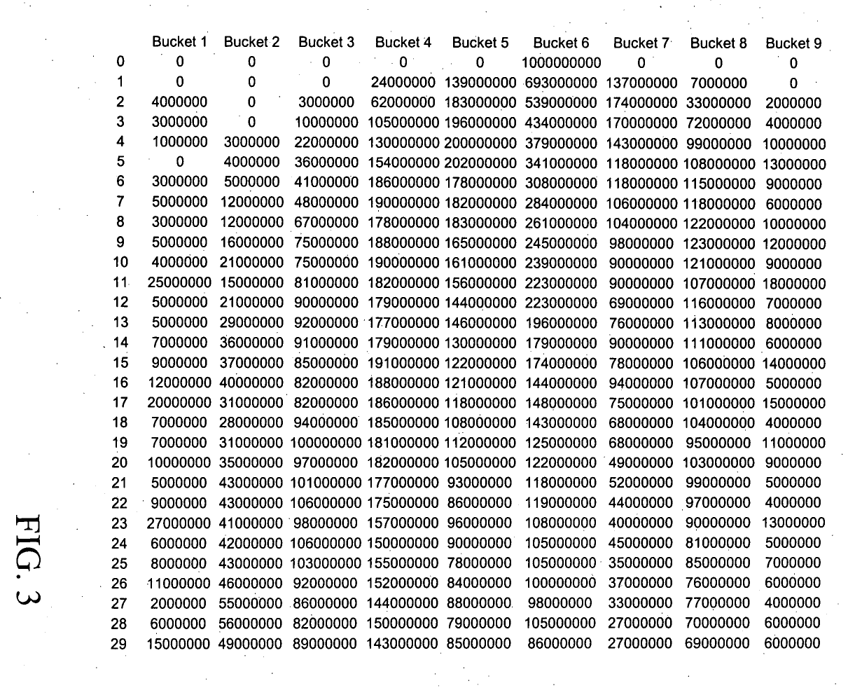

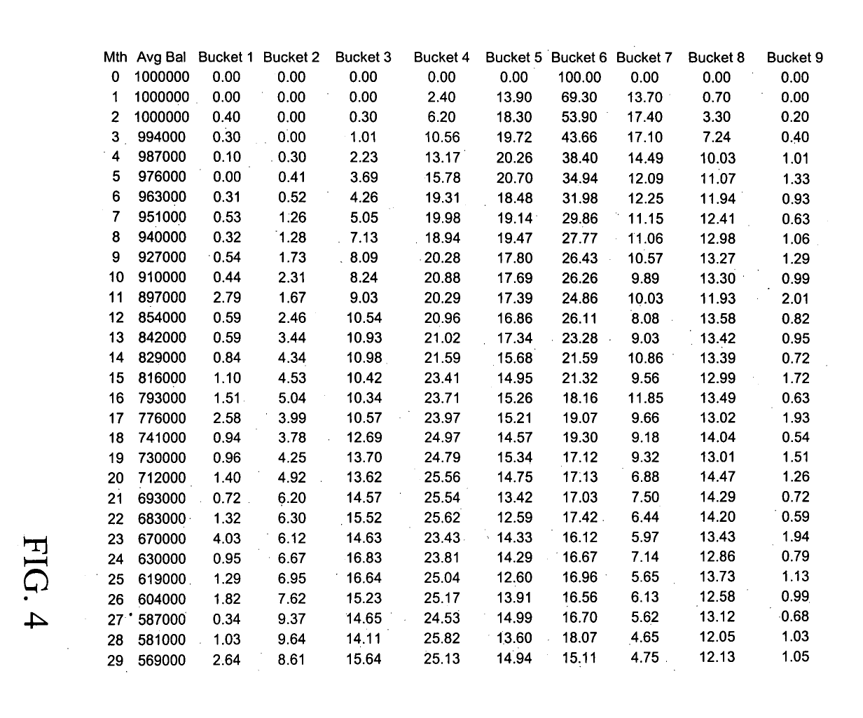

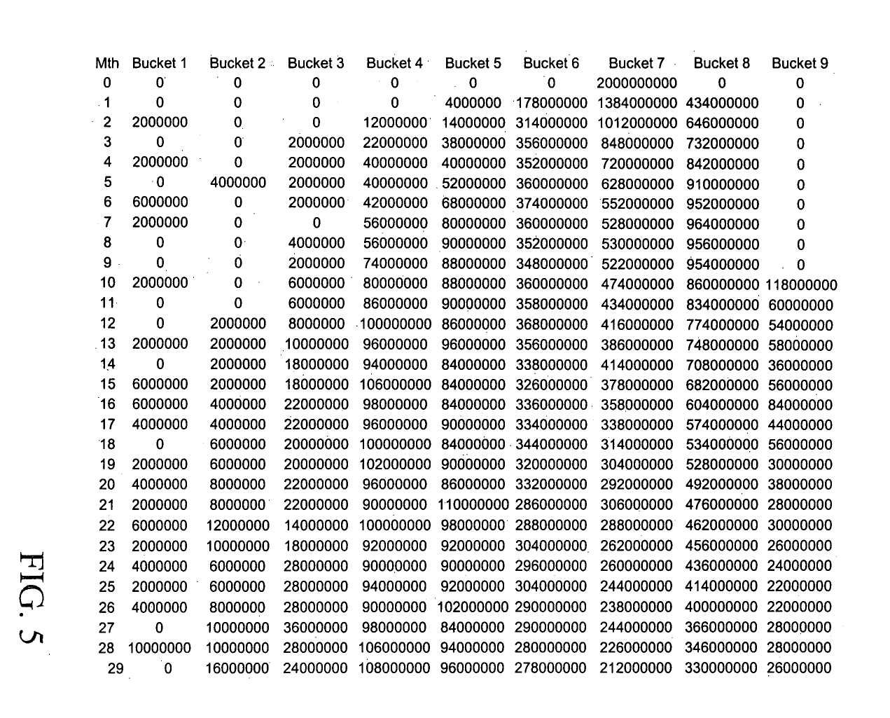

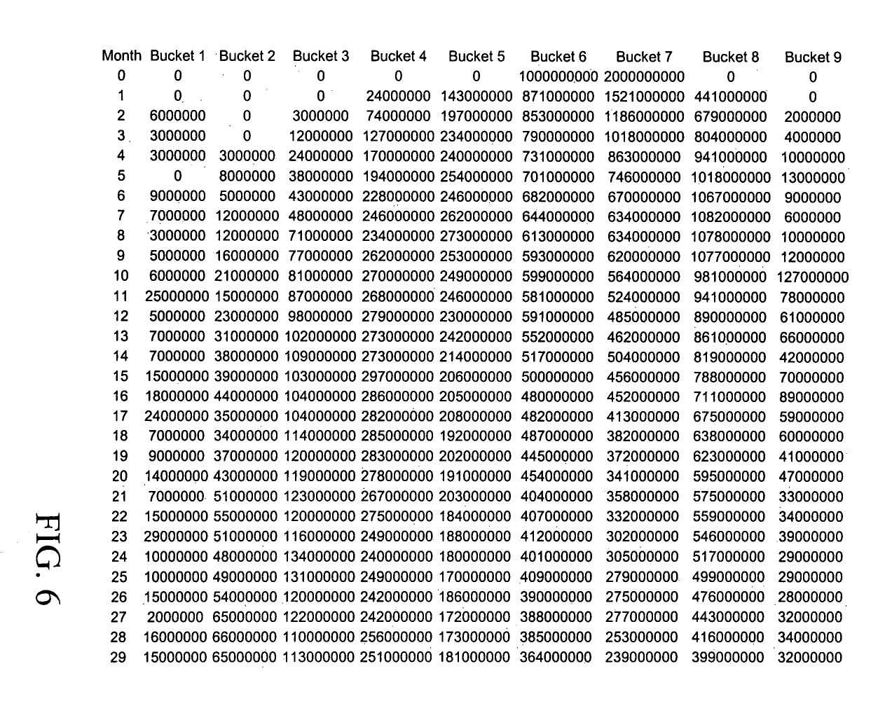

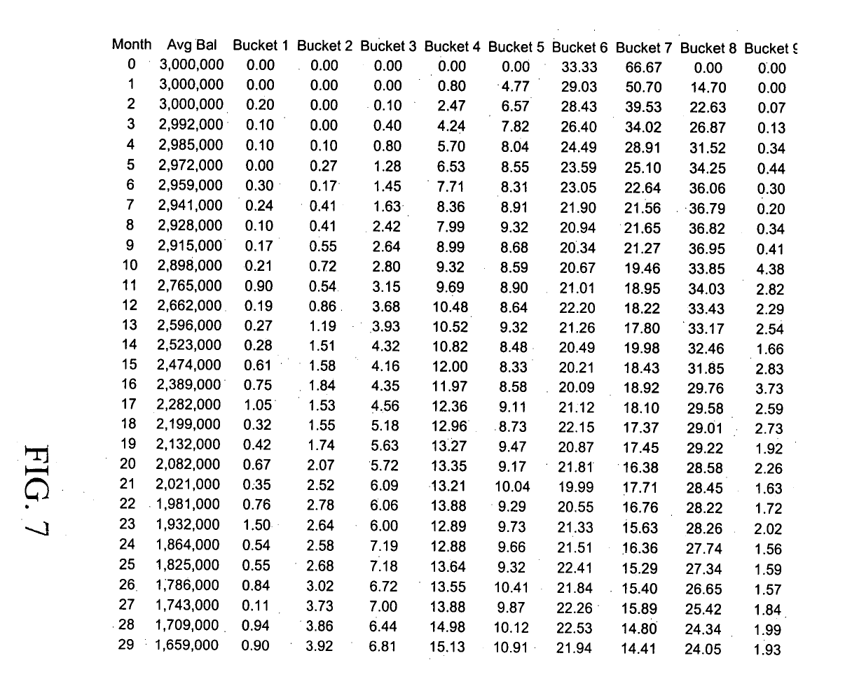

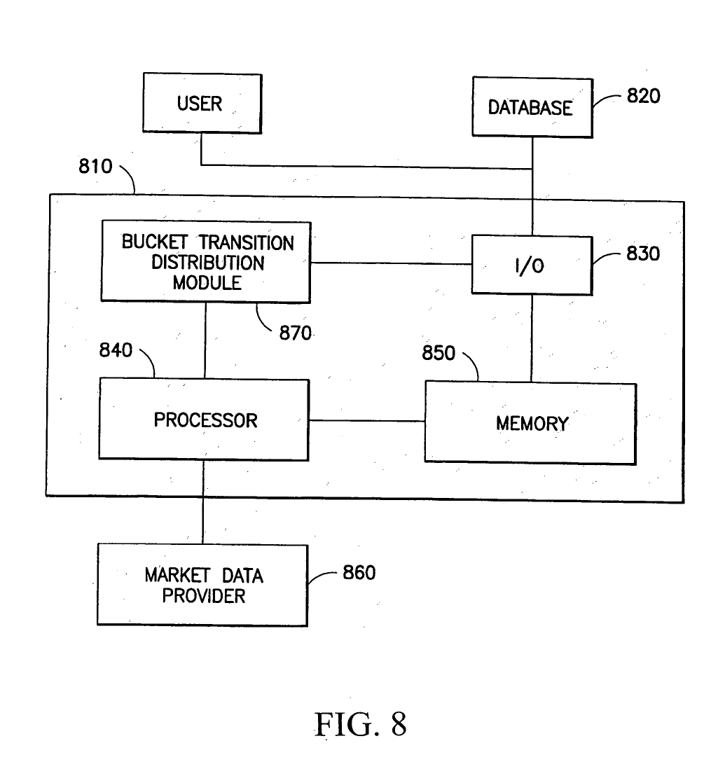

FIG. 4 is a percentages matrix derived from the combined matrix of FIG. 3 according to an exemplary embodiment of the present invention.

FIG. 5 is a cumulative balance matrix of bond price transitions between buckets according to an exemplary embodiment of the present invention.

FIG. 6 is a cumulative balance matrix of a CDO portfolio according to an exemplary embodiment of the present invention.

FIG. 7 is a percentages matrix for a CDO portfolio derived from the matrix of FIG. 6 according to an exemplary embodiment of the present invention.

FIG. 8 is a block diagram illustrating a system for evaluating and pricing credit risk according to one embodiment of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with illustrative embodiments. It is intended that changes and modifications can be made to the described embodiments without departing from the true scope and spirit of the subject invention, as defined by the appended claims.

### DETAILED DESCRIPTION OF CERTAIN EMBODIMENTS

In general, the methods and systems according to the present invention provide a grouped, discrete price framework for analyzing and estimating the random behavior of the bonds in a particular CDO. The systems and methods provide a structural model for calculating the bucket transition probabilities of bonds in the CDO portfolio moving between different price states, including default, call and recovery (referred to herein as buckets), using one or more observable attributes.

The bucket transition probabilities are then used in a simulation framework to estimate the time of default, call or recovery on each bond. The framework further provides cumulative default, call and/or recovery estimates for each bond transaction. Thus, by tying these estimates to observable attributes, the framework may be used to classify CDO bonds as potential defaulters as opposed to non-defaulters. This enables the CDO managers to analyze the risk-reward profile of an investment. Hence, the systems and methods herein provide a consistent framework for determining the value of CDOs.

It is to be understood that although the embodiments described herein are in the context of bonds underlying CDOs, the present invention may be applied to other derivatives and underlyings. In such embodiments, different observable attributes tailored to such derivatives and underlyings would be used.

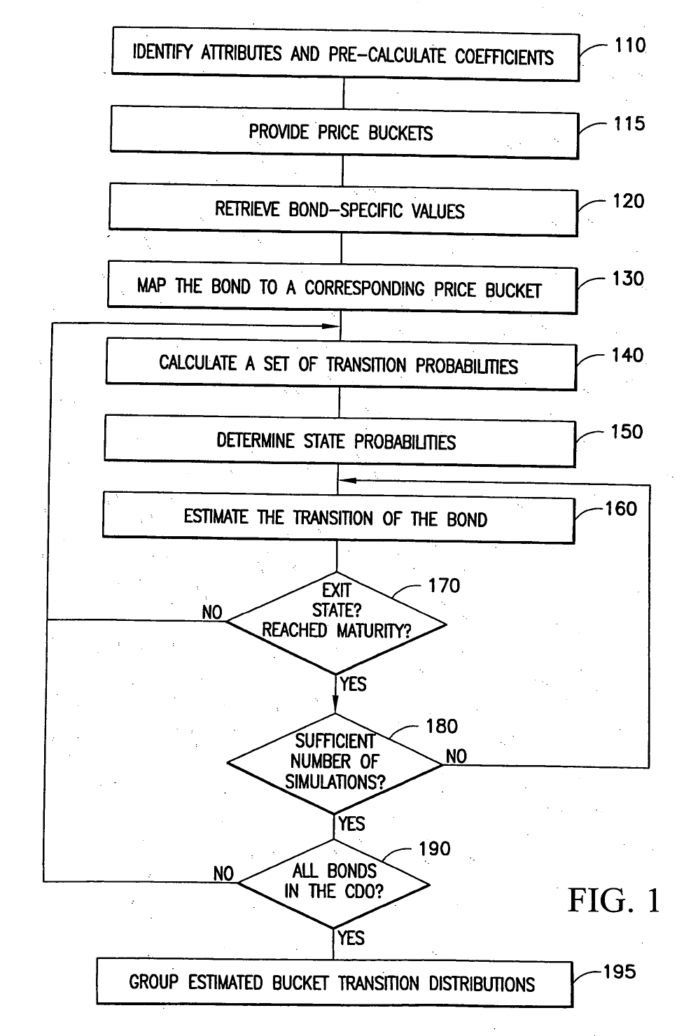

Certain embodiments of the present invention will now be described in greater detail with reference to the foregoing figures. Turning first to FIG. 1, the overall method for estimating bucket transition distribution according to the present embodiment is shown. In general, the process involves running a series of price movement simulations. More specifically, as an initial step, one or more observable attributes are identified and a set of coefficients corresponding to those attributes are pre-calculated. (Step 110).

In general, observable attributes are objective indicia of price or price movement. It should be understood that the present invention is independent of the particular attributes and, as such, may be implemented with any attributes deemed relevant to the subject derivative. The coefficients are essentially multipliers that are pre-calculated using historical data to reflect each attribute's influence on the bucket transition probabilities of a bond for any given time period or trial. As such, the coefficients may be calculated by maximum likelihood estimation of discrete choice model, as described in Sueyoshi, Glen, A Class of Binary Response Models for Grouped Duration Data, Journal of Applied Econometrics, 10(4):411-431 (1995). As with the attributes, the present invention is independent of the specific coefficients used and, consequently, may be implemented using any coefficients.

One of the observable attributes is price. Other attributes include, for example, number of months in a particular price bucket, at a particular price, or in the same price bucket, industry sector (e.g., Moody Industry Sector), original issue size, coupon dates, coupon, exposure size, maturity date, dated date, 10-yr treasury value on dated date, whether the bond was ever investment grade (“fallen angels”), call dates, sink dates, macro-economic conditions, such as rating spreads, e.g., B spreads, BB spreads and B/BB spreads and the like. As is known in the art, B spreads and BB spreads represent the difference between a yield on a B rated, or BB rated bond and a corresponding Treasury bond with matching maturity date. B spreads and BB spreads can also be calculated for the whole portfolio by using a weighted average of individual B or BB spreads. B/BB spread represents a difference between a B spread and BB spread for a particular portfolio.

Additionally, a set of at least two price buckets is established (step 115). In an embodiment in which the analysis is concerned primarily with default, a minimum of two buckets are used—one indicating default and one indicating all other prices. In another embodiment in which the analysis is concerned primarily with call rates, a minimum of two buckets also are used—one indicating a call and another indicating all other prices, including default. It will be appreciated based on the discussion herein that the optimum number of buckets depends upon the price range(s) used for the buckets in the framework, as well as on a number of bond states that are to be taken into account by the framework—too few price buckets results in too little data and poor accuracy, while too many price buckets results in noisy data. It has been found, however, that nine buckets, as described in connection with the example of FIG. 2, is suitable for most CDOs. Furthermore, while the present embodiment uses buckets of certain varying sizes, other sized buckets (i.e., different price ranges) may be used, including, for example, buckets of uniform size.

Then, each bond in the subject CDO portfolio is identified (e.g., by CUSIP), and a set of bond-specific values corresponding to the identified observable attributes are identified. The bond-specific attribute values may vary with time, e.g., bond price at various callable dates, or be time-independent, e.g., an original issue size.

Based on the current price of the bond, the bond is mapped in step 130 to the appropriate price bucket. Once mapped to a particular price bucket, a set of bucket transition probabilities, namely, the probabilities of the bond transitioning from one bucket to each other bucket for a particular time period (for example, a month in the present embodiment), is calculated in step 140 for the bond. The bucket transition probabilities for the bond are then summed in step 150 to determine the probabilities for each possible future state (i.e., transitioning from the current bucket to each other bucket or staying in the same bucket).

The process continues with the simulation of price movement for the bond. More specifically, the transition of the bond mapped from the current price bucket to an alternative price bucket in the future is estimated in step 160 based on the state probabilities, as determined in step 150, and a uniform random variable. As described in greater detail below, using the state probabilities and a uniform random number that falls within any one of those states, the method determines, probabilistically, which bucket the bond will be in during the subsequent time period, i.e., month.

The process of determining bucket transition probabilities and state probabilities, and using a uniform random number to estimate the price bucket in which the bond will fall (steps 140-160), is repeated for subsequent months in the simulation until the simulation results in the bond defaulting, the bond being called or the maturity date (e.g., 30 months) for the bond has been reached (step 170), thereby establishing a simulation for the bond. In alternate embodiments, the simulations are performed over other time periods, such as a predetermined number of months. For each month in the simulation, the method involves calculating new bucket transition and state probabilities based on the starting bucket for that month, as determined by the prior application of step 160. Additionally, any values dependent on the time period are recalculated.

Once steps 140-170 are repeatedly performed to obtain a complete simulation, these steps are repeated to obtain additional simulations for the same bond until a sufficient number of simulations are obtained (step 180). In the present embodiment, one thousand simulations are used, which has been found to provide generally acceptable results for most bonds, although the present invention encompasses using any number of simulations. In general, the number of simulations represents a tradeoff between accuracy resulting from increased number of simulations (although after a certain number of simulations, the marginal increase in accuracy is nominal) and cost (both in time and processing power) of performing the increased number of simulations.

As described in greater detail below, with the simulations performed for the bond, the results from all simulations can be combined to obtain the bucket distribution for the bond. More specifically, the simulations identify, on a month-by-month basis, the instances in which the bond defaults (or is called) in each of the simulations. The bond's default rates for any given time period may then be found in the bucket distribution. Cumulative default rates for multiple months can also be calculated from the bucket distribution by summing the default rates for each included month.

Once the requisite number of simulations is obtained for a bond, the process is repeated for the next bond in the portfolio. The process repeats until simulations have been created for all bonds in the CDO portfolio (step 190). The bucket transition distributions of all the bonds in the CDO portfolio may then be grouped in step 195 to determine a combined bucket transition distribution for the CDO portfolio. The combined bucket transition distributions may then be used by CDO portfolio managers to rank CDO portfolios based on default probabilities, as well as to evaluate the interaction between collateral credit quality and structure to determine relative value of the portfolio or take any action based thereon.

As previously noted, at least one observable attribute is identified in step 110, and a corresponding set of coefficients representing each attribute's influence on the bucket transition probabilities of a bond for any given bucket, time period and/or trial is pre-calculated based on historical data. Each of these identified attributes may have an impact on the bucket transition distribution.

For example, the default rate for telecom related bonds has been significantly higher than for non-telecom bonds. Forty-three percent (43%) of all telecom bonds issued during the period between December 1997 and June 2002 defaulted. The textile and mining sectors follow thereafter with lower default rates. Conversely, the utilities, the printing and publishing, and broadcasting and entertainment sectors had a lot lower default rate. The inter-sector default correlations are obtained through the sector flags, which uniformly raise or lower the probability of default, calls or price transitions for all bonds within the sector. The cross-sector correlations are generated through the systemic BB spread and the B/BB credit curve impacts. These serve as proxies for general, economy-wide shocks and capital market conditions, such as investor's risk-aversion levels.

Similarly, a greater number of months a bond stays in a distressed price bucket may mean that the bond is more likely to stay distressed but not default. This may be used, for example, with respect to valuing a CDO with a substantial proportion of low dollar price bonds that are “young,” as opposed to the bonds that have been trading at very distressed levels for a relatively greater period.

The absolute bond coupon has an impact on both price upgrade as well as downgrade ratios. Generally speaking, bonds issued with a lower coupon have higher price upgrade ratios and lower downgrade ratios. In other words, the lower the coupon at issue, the more likely it is that a bond will transition to a higher dollar price bucket and the less likely it is that the bond will decline to a lower dollar price bucket.

Coupon payment date is another attribute that may be considered. Most defaults and calls occur in the payment month. Hence, a dummy variable may be used to represent whether a projection time period is a payment date for a specific issue, when the risk of defaults and calls may be heightened.

Bonds issued as investment grade that have subsequently been downgraded to fallen angel status constitute a large share of the outstanding speculative grade universe of bonds during times of credit stress. To the extent they are available to be purchased by speculative grade buyers, it is important to understand their price transition dynamics. Fallen angels tend to have higher upgrade probabilities, i.e., higher probabilities of moving to a higher price bucket, for most price buckets. In addition, they have lower price downgrade rates, i.e., lower probabilities of moving to a lower price bucket, for each price bucket than their original issue speculative grade counterparts. This indicates greater stability in price movements.

The overall macro-economic environment also plays a role in influencing overall default rates. The default rates tend to rise during economic contractions and decline during an expansionary phase. These price transitions, and ultimately default rates, may be explained using the slope of the credit curve, i.e., the difference between B and BB yields in a high-yield index as a measure of the capital market's access to liquidity. An increase in the market's demand for high-yield bonds inevitably leads to a compression in the B/BB credit curve. This allows companies whose bonds may have declined in price to recover from their temporary misfortunes more easily than in a situation when credit markets are more risk averse and liquidity on perceived riskier names is tight. When viewed in this framework, the behavior of the credit curve can serve to provide a leading indicator for default rates.

The macro-economic proxy coefficients, V and W, representing the BB spread and the credit curve between B and BB spreads, respectively, as captured by the periodic (e.g., monthly) changes dV and dW, respectively, are expected to evolve according to the following random processes:

dV=(a+bV)dt+cV^{d}dZ_{V}

dW=(e+fW)dt+gW^{h}dZ_{w}

where a, b, e and f are drift parameters, indicating the tendency of spreads to move closer to the historical means, and c, d, g and h are historical volatility parameters indicating the degree of randomness of spreads.

The correlation coefficient between the two stochastic processes is represented by the relationship E(dZ_{V} dZ_{w})=ρdt. Here, dt represents a unit time interval, e.g., one month, while dZ_{V} and dZ_{w} are random standard normal shocks to the process with a correlation coefficient equal to ρ. The parameters a, b, c, d and e, f, g, h are estimated using Generalized Method of Moments (GMM), as described in L. P. Hansen, Method of Moments, International Encyclopedia of the Social and Behavior Sciences, N.J., Pergamon: Oxford (2001). ρ is estimated from the correlation between the changes dV and dW. The “real” probability density of V and W can be simulated using these two stochastic processes, which revert to historical average BB spreads and the credit curve between B and BB bonds. Forward rates for V and W can also be estimated from current pricing on a representative sample of BB and B securities as is known in the art.

A difference in 10-yr Treasury rates from the issue date is another determinant of price dynamics. Bond price movements tend to be more correlated with treasury yields for bonds trading around or above par.

Since each of the identified attributes has an impact on the bucket transition probabilities, such an impact is taken into account in the present embodiment by pre-calculating for each attribute a set of corresponding coefficients based on historical data, and using those sets of coefficients in calculating the bucket transition probabilities. In general, the greater the potential impact of the attribute as compared to other attributes, the greater the coefficient; the greater the potential impact of the attribute with changes in the value of the attribute, the greater the coefficient; and the greater the potential impact on movement from a particular price bucket to another price bucket, as compared to movement to another price bucket, the greater the coefficient.

For example, if it was determined based on historical data that a bond's coupon had a more direct influence on whether a bond transitioned from bucket 6 to bucket 5 than from bucket 6 to bucket 7, the 6-5 coupon coefficient would be relatively, for example, proportionally larger than 6-7 coupon coefficient.

Furthermore, some of the attributes are bond-specific but do not vary between a given time period and a given trial. For example, the telecommunications flag may be set to “1” if the bond is in the telecommunications industry, and “0” otherwise; indeed, the industry coefficient is binary in the present embodiment (i.e., “0” if the bond does not relate to a particular industry and “non-zero” if the bond does relate to that industry). Other attributes, for example the B/BB spread, vary by month and by trial because the difference between B spread and BB spread changes every month, and because there is a random shock associated with the generation of the BB spread curve in each trial.

Having described an embodiment, a specific illustrative example using a hypothetical CDO of two bonds, Arch Wireless and United Rentals, will now be described in greater detail. The present embodiment includes the following nine buckets, of which seven are price buckets and two are state buckets (i.e., defaulted and called):

| | |
|---|---|
| Bucket 1 | Defaulted |
| Bucket 2 | $0-$25 |
| Bucket 3 | $25-$50 |
| Bucket 4 | $50-$75 |
| Bucket 5 | $75-$85 |
| Bucket 6 | $85-$95 |
| Bucket 7 | $95-$100 |
| Bucket 8 | Over $100 |
| Bucket 9 | Called |

The first illustrative bond is Arch Wireless 12% May 15, 1999 having a CUSIP of 039392ABI. The bond has a non-fallen angel status, an average price of $95 as of August 2003, has spent two months in the same price bucket, belongs to the telecommunications industry, has an original issue size of 100,500,000, semi-annual payment frequency, 12% coupon, portfolio par amount of 1,000,000, maturity date of May, 15, 2009, Dated Date of May 29, 2002, 10-yr Treasury Value on Dated Date of 5.140257, no sink dates and three call dates (1. callable from May 29, 2002 until May 15, 2007 at $106; 2. callable from May 15, 2007 until May 15, 2008 at $104; and 3. callable from May 15, 2008 until May 15, 2009 at $102).

The second illustrative bond is United Rentals Bond 9%, Apr. 1, 2009, having CUSIP 911363AH2; non-fallen angel status, price of $96.047 as of August 2003, has spent one month in the same price bucket, belongs to the machinery industry, has an issue size of 250,000,00, semi-annual payment frequency, 9.1% coupon, portfolio par amount of 2,000,000, Maturity Date of Apr. 1, 2009, Dated Date of Mar. 23, 2003, 10-yr Treasury Value on Dated Date of 5.22644, no sink dates and four call dates (1. callable from Apr. 1, 2004, until Apr. 1, 2005 at $104.5; 2. callable from Apr. 1, 2005 until Apr. 1, 2006 at $103; 3. callable from Apr. 1, 2006 until Apr. 1, 2007 at $101.5; and 4. callable from Apr. 1, 2007 until maturity at $100).

Beginning with the first bond—Arch Wireless, it is mapped to one of the nine buckets. Since the first bond has a current price of $95, it is mapped to price bucket 6.

The expected bucket transition probabilities are then calculated for each month. The first bond is in bucket 6 in month “0”, the current month, since its price is $95. The probability of transitioning from one price bucket to another is represented as:

P(j,k,t)=1−exp \hat{ }(−exp \hat{ }(A(t)+X(β))),

where P(j, k, t) represents the probability of a bond transitioning from bucket j (a starting state) to bucket k (an ending state) after spending t months in bucket j (=2, 3, . . . 8 while k=1, 2, 3, . . . 9). A(t) is a parameter representing the number of months that a bond has stayed in the same price bucket and X(β) is a function of other bond-specific and macro-economic attributes. In this embodiment, this bond is analyzed using the following attributes: issue size, coupon date, sector flag, coupon rate, maturity, the Bear Stearns High Yield Index (BSIX), BB spread (Y), and the difference between BSIX B and BB spreads (Z). β represents the coefficient or relative weight assigned to each attribute determining transition probabilities. This representation of the bucket transition probabilities is the grouped equivalent of a continuous-time proportional hazard model where defaults or price movements are known to lie within an interval, e.g., a month. All estimates are obtained through a maximum likelihood technique.

Thus, for the Arch Wireless bond, the probability of going from bucket 6 to bucket 1 is calculated as 1−e\hat{ }(−e\hat{ }(A(t)+X(β))), where A (t)+X(β) equals:

$$\begin{matrix}( 6 \text{-} 1 intercept ) + \\ ( 6 \text{-} 1 months in bucket = 2 coefficient ) + \\ ( coupon * 6 \text{-} 1 coupon coefficient ) + \\ ( telecom flag * 6 \text{-} 1 telecom coefficient ) + \\ ( finance flag * 6 \text{-} 1 finance coefficient ) + \\ ( leisure flag * 6 \text{-} 1 leisure coefficient ) + \\ ( mining flag * 6 \text{-} 1 mining coefficient ) + \\ ( textile flag * 6 \text{-} 1 textile coefficient ) + \\ ( utility flag * 6 \text{-} 1 utility coefficient ) + \\ ( airline flag * 6 \text{-} 1 airline coefficient ) + \\ ( B BB spread * 6 \text{-} 1 B BB spread coefficient ) + \\ ( BB spread * 6 \text{-} 1 BB spread coefficient ) + \\ ( coupon date flag * 6 \text{-} 1 coupon date coefficient ) + \\ ( even investment grade flag * 6 \text{-} 1 even investment grade coefficient ) + \\ ( remaining months * 6 \text{-} 1 remaining months coefficient ) + \\ ( ten year treasury spread * 6 \text{-} 1 ten year treasury spread ) + \\ ( ( original balance / 1000000 ) * 6 \text{-} 1 original balance coefficient ) = \\ - 8.16978838 + 1.45774402 + ( 12 * 0 ) + ( 1 * 0 ) + ( 0 * 0 ) + ( 0 * 0 ) + \\ ( 0 * 0 ) + ( 0 * 0 ) + ( 0 * 0 ) + ( 0 * 0 ) + ( 137.349369 * 0 ) + \\ ( 373.7186938 * 0 ) + ( 0 * 0 ) + ( 0 * 0 ) + ( 70 * 0 ) + ( 156.025716 * 0 ) + \\ ( 0.1005 * 0 ) = \\ = - 6.71204436 , \\ s o P ( 6 , 1 , 2 ) = 0.001215436037 .\end{matrix}$$

(6-1 intercept) represents a price bucket coefficient, which indicates the relative influence of the bond being in bucket “6” on the bond's likelihood of transition to bucket “1”, when all other coefficients are discounted. A price coefficient, specific to the actual bond price, could be used instead of the price bucket coefficient, specific for a price bucket, without departing from the spirit and scope of the invention. (6-1 months in bucket) coefficient represents the relative likelihood that the bond, having spent a given number of months in bucket 6, would move to bucket 1, when all other coefficients are discounted. (6-1 coupon coefficient) represents the relative likelihood that the bond, having a particular coupon, would move from bucket 6 to bucket 1, when all other coefficients are discounted. Telecom, finance, leisure, mining, textile, utility and airline 6-1 coefficients represent the industry sector coefficients indicating the relative likelihood that the bond, belonging to a given sector would move from bucket 6 to bucket 1, when all other coefficients are discounted. BB and B/BB spread coefficients represent the macro-economic conditions coefficients, indicating the relative likelihood that the bond would move from bucket 6 to bucket 1, given the BB spread and B/BB spread coefficients and discounting all other coefficients. Similarly, all the remaining coefficients, i.e., 6-1 coupon date coefficient, 6-1 ever investment grade coefficient, 6-1 remaining months coefficient, 6-10-yr. Treasury spread coefficient, and 6-1 original balance coefficient represent the respective relative influences indicating the likelihood that a particular bond would move from bucket 6 to bucket 1, given the particular attribute and discounting all others.

Notably, most of the coefficients in this example are 0, which means that the particular bond attribute does not influence the price transition from bucket 6 to bucket 1.

For each projection date, P(j,k,t) is computed for each possible (j,k) pair. For each projection month, the bond price bucket is known for the prior month through the simulation.

Solving all of the transition states in the same method:

Probability of going from bucket 6 to bucket 1=0.00121544;

Probability of going from bucket 6 to bucket 2=0;

Probability of going from bucket 6 to bucket 3=0;

Probability of going from bucket 6 to bucket 4=0.01975084;

Probability of going from bucket 6 to bucket 5=0.11093893;

Probability of going from bucket 6 to bucket 7=0.13322889;

Probability of going from bucket 6 to bucket 8=0.00729262; and

Probability of going from bucket 6 to bucket 9=0.

Since the sum of all of these probabilities is 0.27242671, the probability of staying in bucket 6 is: 1-0.27242671=0.72757329.

At this point, the cumulative probabilities C(6,k) are computed for each possible future state k. The probabilities from the lowest state to the highest state are then summed to get the probability states between 0 and 1. Such cumulative probabilities for transitioning from bucket 6 to bucket k are equal to: C(6,k)=ΣP(6,i,t), i=1 . . . k, where P is the probability of transitioning from bucket 6 to bucket i, up to bucket k.

For this first bond, the probability states, based on the bond currently being in bucket 6, are:

between 0 and 0.00121544=Bond transitions into bucket 1;

between 0.00121544 and 0.02096627=Bond transitions into bucket 4;

between 0.02096627 and 0.13190520=Bond transitions into bucket 5;

between 0.13190520 and 0.85947849=Bond stays in bucket 6;

between 0.85947849 and 0.99270738=Bond transitions into bucket 7; and

between 0.99270738 and I=Bond transitions into bucket 8.

Notably the largest probability is that the bond will stay in the same state. Also note that all of the states whose transition probability is 0 have been discarded.

At this point, the transition of a bond mapped in one price bucket to an alternative price bucket in the future may be estimated by drawing a uniform random number (U) between 0 and 1, which determines the state to which the bond transitions in the simulation. In the present embodiment, determining the random number involves first determining a starting seed as a fraction of the security identifier, e.g., Bear Stearns security identifier, for the bond and the number of the simulation. The seed is then used to generate a random number for each month in the simulation. A transition to state (k−1) is made if U lies between C(6,k−1) and C(6,k). Assuming U=0.86469912, which may be drawn using a software program, the bond transitions into bucket 7 in month 1 (e.g., July 2003) in trial 0.

This process is repeated in step 170 for month 2 (e.g., August 2003) and thereafter, until the bond reaches an exit state (either bucket #1 (defaulted) or bucket #9 (called)) or until the maturity month of the bond is reached. The probabilities are now calculated based on a starting bucket 7, and any month dependent numbers are recalculated (for example, the BB spread will now be 324.1611918 instead of 373.7186938). In this case, the cumulative probability states for the second month are:

between 0 and 0.00031023=Bond transitions into bucket 1;

between 0.00031023 and 0.00441997=Bond transitions into bucket 5;

between 0.00441997 and 0.17105704=Bond transitions into bucket 6;

between 0.17105704 and 0.77264165=Bond stays in bucket 7;

between 0.77264165 and 0.97804391=Bond transitions into bucket 8; and

between 0.97804391 and 1=Bond transitions into bucket 9.

A new random number is drawn, such as 0.3007767, in which case the bond stays in bucket 7 in August 2003. For this bond, because the number of months between the start date and the maturity date is seventy, there can be at most seventy repetitions of this process per trial and fewer if the trial indicates a default (bucket 1) or call (bucket 9) before the seventieth month.

The information that can be derived from the simulations will now be described in the context of a matrix whose columns are the price buckets and the rows are the months. As with the other matrices discussed herein, the matrix is an exemplary logical representation of the data, which can be implemented in software. Such an exemplary matrix showing the first 30 months of a trial for the first bond is shown in FIG. 2. Referring to FIG. 2, each field in a particular row is filled with either 0 or the amount of the bond for that month if the bond is estimated to be in that bucket at that month of the trial. Each row should have eight fields with “0” and one field with the current amount of the bond, since a bond can only be in one state at a time. Because the bond transitioned into bucket 9, an exit state, in month 11, the simulation was ended at that point.

This entire process is then repeated for a pre-determined number of simulations or trials (in the present embodiment, 1000 simulations). The starting price bucket of each simulation is bucket 6, since that is a known value for the current or starting month. The 1000 matrices representing the 1000 trials may be combined together into a single matrix for the bond, as illustrated in FIG. 3. Each field in the combined matrix contains a sum of the corresponding fields from all 1000 matrices. For example, the field corresponding to month 1, bucket 1 of the combined matrix has a value equal to the sum of the value for the same field in each of the 1000 matrices.

The combined matrix can be converted into a matrix of percentages by dividing each cell by the sum of the balances in its particular row and then multiplying by 100. This will yield the percentages matrix, shown in FIG. 4. The percentages matrix provides an entire bucket transition distribution for the bond. Any one-month default rate can be found for a given month by simply looking at the percentage for bucket 1 (i.e., default bucket) for that month. For example, referring to FIG. 4, the one-month default rate in month 16 is 1.51%.

A cumulative default rate also can be calculated for any number of periods by multiplying each default rate by a corresponding average balance for that period to yield that period's defaulted balance, summing the defaulted balances and dividing the sum, which represents the total amount of defaulted balance, by an average balance for the beginning time period. For example, the 10-month default rate is determined by first multiplying the default rates for each of the first ten months with the corresponding average balances for those months, summing the results and dividing it by the average balance for the first month. The average balance for the first month is determined by adding all the balances in the first row of FIG. 3, and dividing the result by the number of simulations, i.e. 1000. In this example, the average balance for the first month is (0+0+0+0+0+1,000,000,000,000+0+0+0)/1000=1,000,000,000. The average balances for the remaining nine months are similarly determined.

Then, the default rates for the first ten months are multiplied with the corresponding average balances to determine the default balances, which are then are summed: (1,000,000,000*0%+1,000,000*0%+1,000,000*0.4%+994,000*0.3%+987000*0.1%+976,000*0%+963,000*0.31%+951,000*0.53%+940,000*0.32%+927,000*0.54%) 24,008.40. Finally, the sum is then divided by the average balance for the first month: 24,008.40/1,000,000=2.4%.

One-month and cumulative rates corresponding to any other bucket (e.g., call rates corresponding to bucket 9) can be similarly calculated. Moreover, percentages of multiple buckets can be combined for a single month or for multiple months. For example, a combined default and call rate for a particular period (e.g., month 3) can be calculated by summing the percentages for both buckets in month 3 (0.3+0.4=0.7%). In case that a combined default and call rate for the first ten (10) months is needed, the default and call rates are added for each month and multiplied by the corresponding average balance for that month to determine that period's defaulted/called balance, the defaulted/called balances for ten (10) months are summed and then the sum is divided by the average balance for the first month ((0%*1,000,000+0%*1,000,000+0.6%*1,000,000+0.7%*994,000+1.1 1%*987,000+1.33%*976,000+1.24%*963,000+1.16%*951,000+1.38%*940,000+1.83%*927,000)/1,000,000=8.98%).

In summary, after repeating the simulation for a pre-determined number of times, the results are combined and then converted into percentages, which represent the entire bucket transition distribution for the bond.

The same process of determining the bucket transition distribution is repeated for the remaining bonds in the CDO portfolio, in this case for the second bond—United Rentals. An illustrative combined 1000-simulation matrix for the second bond is shown in FIG. 5. This matrix is then converted into a percentages matrix to provide an estimated bucket transition distribution for the second bond.

The estimated bucket transition distributions of all the bonds in the CDO portfolio may be grouped to determine a combined bucket transition distribution for the CDO portfolio. More specifically, a combined transition distribution for the entire bond portfolio comprising the CDO is determined by adding the values in the same field of the two matrices. In the present embodiment, the two combined 1000 trial matrices can be added (one for each bond) to arrive at a total 1000 trial matrix for the entire portfolio, as shown in FIG. 6.

The resulting CDO matrix can be converted to a matrix of percentages in the same manner as described above for individual bonds. An illustrative percentages matrix for the CDO portfolio is illustrated in FIG. 7.

Note that a column called average balance has been added in FIG. 7. For each row (e.g., month), the average balance is the sum of the balances across the row divided by the number of trials, in this example 1000. From this table, data for the CDO portfolio may be obtained, including CDO default and/or call rates for a single period or cumulative over multiple periods. For example, the default rate in month 20 is the value in month 20 for the bucket, namely, 0.67%. Similarly, the default rate for the first ten months is 1.21%. The price of the bond in the month of default is used as a proxy for the recovery rate after default. The recovery rate value may be stored, e.g., in a recovery rate bucket.

An exemplary system for implementing the foregoing functionality will now be described with reference to FIG. 8. Referring to FIG. 8, a system 800 includes a processing subsystem 810 and a database 820. The processing subsystem 810 further includes an input/output (I/O) communication interface 830, a processor 840 and a memory 850. The subsystem 810 is coupled to a market data provider 860, which provides historical and/or current market data, via any of a number of networks, such as a local area network, wide area network, the Internet, wireless network, virtual private network and the like, utilizing essentially any type of communication protocol, such as Ethernet, IP addressing, and the like. Some exemplary market data providers include third party providers, real-time providers, stored data providers and the like.

The subsystem 810 also includes a bucket transition distribution module 870 for estimating the bucket transition distributions of the bonds in a CDO portfolio. The bucket transition distribution module 870 is a software object or program running on the processor 840, and may be stored, in memory 850, such as Random Access Memory (RAM), DRAM, or other equivalent memory storage device, for receiving and storing instructions communicated from the processor 840. Memory 850 may also include Read-Only-Memory (ROM), EPROM and other suitable storage devices to temporarily store variable or other intermediate information while the processor 840 executes instructions.

An exemplary bucket transition distribution module 870 is a C program, but other programs may be used without departing from the spirit and scope of the invention. The exemplary bucket transition distribution module 870 includes a module for determining a set of coefficients for each pre-defined attribute, a module for retrieving the corresponding bond attribute values, a module for calculating bond transition probabilities, and a module for performing a simulation to estimate the bucket transition distribution for each bond in the CDO portfolio.

Although one of each component is illustrated, it is to be understood that multiple of any of the components may be utilized. For example, the system may include more than one processor 840 or database 820. Similarly, more than one market data provider 860 may be used, as well as more than one I/O communication interface 830. In the same manner, more than one bucket transition distribution module 870 may be used, each performing one or more functions described herein above. Furthermore, connections to the market data providers, whether direct or indirect, may be via any technology, including those noted above.

In general, the system allows a user to consistently analyze and evaluate CDO portfolios by utilizing a bond-by-bond evaluation of current trading prices, bond-specific attribute values, and the overall state of the credit markets. The user provides certain inputs to the system, such as the CDO portfolio details (e.g., the names of the bonds in the CDO portfolio and the like), which are sent to the memory 850 via the I/O communication interface 830 and the processor 840. The processor then, processing the commands from the bucket transition distribution module 870, retrieves the bond-specific attribute values from the market data provider 860, calculates the bucket transition probabilities for each bond, and estimates the bucket transition distribution based on the Monte Carlo simulation. The resulting output is stored in the database 820 and displayed to the user via the I/O communication interface 830.

For example, the bond-specific attribute values may be retrieved by queuing a database 820 to retrieve bond level information, or by examining the market data. This may be done manually or electronically, using, e.g.; a C++ program. As previously mentioned, the bucket transition probabilities are calculated using the bond-specific attribute coefficients, which are determined using the historical market data. The historical market data may be stored in the database 820 or provided by the market data provider 860, whereas the coefficients may be stored in the database 820 or in memory 850.

The foregoing merely illustrates the principles of the invention. Various modifications and alterations to the described embodiments will be apparent to those skilled in the art in view of the teachings herein. It will thus be fully appreciated that those skilled in the art will be able to devise numerous systems and methods which, although not explicitly shown or described, embody the principles of the invention and are thus within the spirit and scope of the invention.

1. A method for estimating a bucket transition distribution for one or more bonds, comprising the steps of:
identifying a plurality of price buckets;
calculating bucket transition probabilities for a first bond; and
estimating a bucket transition distribution for the first bond using the calculated bucket transition probabilities.

2. The method of claim 1, wherein one of the buckets corresponds to an exit state, and wherein the estimating step includes estimating bucket transitions based on the bucket transition probabilities until the exit state or a maturity date of the first bond is reached, thereby completing a first simulation.

3. The method of claim 2, wherein the exit state is one of a default and a call.

4. The method of claim 1, wherein the estimating includes determining the probability that the first bond is in a particular bucket at a particular time.

5. The method of claim 4, wherein one of the buckets corresponds to a default state and the estimating includes determining a default rate for a particular time period for the first bond.

6. The method of claim 5, wherein the estimating includes determining a cumulative default rate for a number of time periods by summing default balances for each of the number of time periods and dividing the sum by an average balance for a first of the number of time periods.

7. The method of claim 2, further including multiple simulations.

8. The method of claim 2, further including
calculating bucket transition probabilities for a second bond;
estimating a bucket transition distribution for the second bond using the calculated bucket transition probabilities; and
grouping the estimated bucket transition distributions for the bonds, thereby enabling an evaluation of the credit risk of the bonds.

9. A system for estimating a bucket transition distribution for one or more bonds, comprising:
means for identifying a plurality of price buckets;
means for calculating bucket transition probabilities for a first bond; and
means for estimating a bucket transition distribution for the first bond using the calculated bucket transition probabilities.

10. The system of claim 10, further including means for estimating bucket transitions based on the bucket transition probabilities until an exit state, corresponding to one of the buckets, or a maturity date of the first bond is reached, thereby completing a first simulation.

11. The system of claim 10, wherein the exit state is one of a default and a call.

12. The system of claim 9, wherein the means for estimating includes a means for determining the probability that the first bond is in a particular bucket at a particular time.

13. The system of claim 12, wherein the means for estimating includes a means for determining a default rate for a particular time period for the first bond.

14. The system of claim 13, wherein the estimating means includes a means for determining a cumulative default rate for a number of time periods by summing default balances for each of the number of time periods and dividing the sum by an average balance for a first of the number of time periods.

15. The system of claim 9, further including multiple simulations.

16. The system of claim 9 for estimating bucket transition distribution for one or more bonds, further comprising:
means for calculating bucket transition probabilities for a second bond;
means for estimating a bucket transition distribution for the second bond using the calculated bucket transition probabilities; and
means for grouping the estimated bucket transition distributions for the bonds, thereby enabling an evaluation of the credit risk of the bonds.

17. A computer readable medium for estimating bucket transition distribution for one or more bonds, the medium comprising a program that causes a processor to implement the steps of:
identifying a plurality of price buckets;
calculating bucket transition probabilities for a first bond; and
estimating a bucket transition distribution for the first bond using the calculated bucket transition probabilities.

18. The computer readable medium of claim 15, wherein one of the buckets corresponds to an exit state, and wherein the estimating step includes estimating bucket transitions based on the bucket transition probabilities until the exit state or a maturity date of the first bond is reached, thereby completing a first trial.

19. The computer readable medium of claim 16, wherein the exit state is one of a default and a call.

20. The computer readable medium of claim 17, wherein the estimating includes determining the probability that the first bond is in a particular bucket at a particular time.

21. The computer readable medium of claim 18, wherein one of the buckets corresponds to a default state and the estimating includes determining a default rate for a particular time period for the first bond.

22. The computer readable medium of claim 19, wherein the estimating includes determining a cumulative default rate for a number of time periods by summing default balances for each of the number of time periods and dividing the sum by an average balance for a first of the number of time periods.

23. The computer readable medium of claim 16, further including multiple trials.

24. The computer readable medium of claim 16, further including
calculating bucket transition probabilities for a second bond;
estimating a bucket transition distribution for the second bond using the calculated bucket transition probabilities; and
grouping the estimated bucket transition distributions for the bonds, thereby enabling an evaluation of the credit risk of the bonds.

25. A device for estimating a bucket transition distribution for one or more bonds, comprising a processor configured to:
identify a plurality of price buckets;
calculate bucket transition probabilities for a first bond; and
estimate a bucket transition distribution for the first bond using the calculated bucket transition probabilities.

26. The device of claim 25, wherein one of the buckets corresponds to an exit state, and wherein the processor is configured to estimate bucket transitions based on the bucket transition probabilities until the exit state or a maturity date of the first bond is reached, thereby completing a first simulation.

27. The device of claim 26, wherein the exit state is one of a default and a call.

28. The device of claim 27, wherein the processor is configured to determine the probability that the first bond is in a particular bucket at a particular time.

29. The device of claim 28, wherein one of the buckets corresponds to a default state and the processor is configured to determine a default rate for a particular time period for the first bond.

30. The device of claim 29, wherein the processor is configured to determine a cumulative default rate for a number of time periods by summing default balances for each of the number of time periods and dividing the sum by an average balance for a first of the number of time periods.

31. The device of claim 26, further including multiple simulations.

32. The device of claim 26, wherein the processor is further configured to
calculate bucket transition probabilities for a second bond;
estimate a bucket transition distribution for the second bond using the calculated bucket transition probabilities; and
group the estimated bucket transition distributions for the bonds, thereby enabling an evaluation of the credit risk of the bonds.
